(19) United States
(12) Patent Application Publication
(10) Pub. No.: US 2016/0014727 A1
(43) Pub. Date: Jan. 14, 2016

(54) METHODS FOR MULTI-SUBFRAME TRANSMISSION AND RECEPTION OF CONTROL INFORMATION

(71) Applicant: GOOGLE TECHNOLOGY HOLDINGS LLC, MOUNTAIN VIEW, CA (US)

(72) Inventor: Ajit Nimbalker, Buffalo Grove, IL (US)

(21) Appl. No.: 14/330,317

(22) Filed: Jul. 14, 2014

(51) Int. Cl. H04W 72/04

(52) U.S. Cl. CPC H04W 72/042

(57) ABSTRACT

The present disclosure describes methods for multi-frame transmission and reception of control information. According to various embodiments, a base station scrambles bits of a downlink-control information (“DCI”) message using a scrambling sequence that is based on the subframe number of the first subframe of a bundle of subframes. In some embodiments, the scrambling sequence is based on the total aggregated resources used for transmitting the DCI. According to an embodiment, the base station performs this scrambling operation after performing a cyclic-redundancy-check operation. In other embodiments, the base station performs this scrambling operation after carrying out channel encoding. In still other embodiments, the base station performs this scrambling operation after carrying out rate matching.

### TECHNICAL FIELD

The present disclosure relates generally to wireless communication and, more particularly, to methods for multi-subframe transmission and reception of control information.

### BACKGROUND

One area of exploration in wireless communication networking that has recently received increased attention is machine-type communication (“MTC”). A premise of MTC is that there is a need to have unattended devices such as home appliances communicate with wireless networks (e.g., cellular networks). Another premise is that such devices have communication needs that are distinct from devices such as cellphones, tablets, and laptops. One of those distinct needs relates to signal coverage. MTC devices are more likely to be in areas where there is high signal attenuation, making it more difficult to maintain reliable communication links. For example, one can imagine how difficult it might be for a basement humidifier to communicate with a cellular network in light of how much the structure of the house and the layers of earth would tend to attenuate the signal. One way of making signal coverage more robust is to overcome the attenuation by transmitting the signal over a longer period, such as by repeating the same information over multiple instances. This allows the receiving MTC device to accumulate signal energy over a longer duration.

One circumstance in which this repetition principle can be used is in the transmission of downlink-control information (“DCI”). In Third Generation Partnership Project (“3GPP”) communication schemes (such as Long-Term Evolution (“LTE”) Release 8 and above), a base station transmits DCI to a user equipment (“UE”) over a physical downlink-control channel (“PDCCH”) or enhanced physical downlink-control channel (“EPDCCH”). DCI includes physical-layer control information (such as resource allocation and modulation and coding schemes), hybrid automatic repeat request (“HARQ”) information (such as a new-data indicator, a HARQ process number, and a redundancy version), spatial-multiplexing information (such as the number of spatial-multiplexing layers, the precoding matrices, and information regarding the demodulation reference signal), uplink power-control bits, sounding reference signal, and Cyclic-Redundancy-Check (“CRC”) information (for error checking) Initially, a UE is not aware of the exact control channel structure of the transmissions it receives from a base station. Such structure includes the number of control channel elements (“CCEs”) used for transmitting a control channel to the UE and the location of the CCEs. The base station can transmit multiple control channels, any of which may or may not be relevant to the UE. The UE finds the control channel specific to it by attempting to decode each “candidate”—i.e., each set of CCEs on which a particular control channel could be mapped. If checks such as the CRC pass for a candidate control channel, then the UE considers the passing candidate to be the proper control channel. Occasionally, candidates with incorrect DCI contents and an incorrect CRC pass, but these can be discarded using consistency checks. If the same DCI is repeated over multiple subframes, however, the UE may have trouble identifying the subframe in which the DCI first appeared. This is significant because the UE may need to use that first subframe as a marker to identify where the data transmissions in the uplink and the downlink directions begin. For example, if the UE is supposed to start transmitting uplink data four subframes after the subframe in which the DCI first appeared, then decoding the wrong candidate can cause the UE to transmit data at the wrong time.

### BRIEF DESCRIPTION OF THE SEVERAL VIEWS OF THE DRAWINGS

While the appended claims set forth the features of the present techniques with particularity, these techniques may be best understood from the following detailed description taken in conjunction with the accompanying drawings of which:

FIG. 1 is a block diagram of a communication system;

FIG. 2 is a block diagram of a representative UE or base station;

FIG. 3 is a block diagram showing a series of subframes and how a DCI is repeated on multiple subframes of a subframe bundle;

FIG. 4 is a block diagram showing a series of subframes and how they are grouped together within candidate search spaces;

FIG. 5A, FIG. 5B, and FIG. 5C are block diagrams of different types of signal-processing modules for a UE;

FIG. 6A, FIG. 6B, and FIG. 6C are block diagrams of different types of signal-processing modules for a base station;

FIG. 7 is a flowchart depicting a method carried out by a base station; and

FIG. 8 and FIG. 9 are flowcharts depicting methods carried out by a UE.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The present disclosure describes methods for multi-frame transmission and reception of control information. According to various embodiments, a base station scrambles bits of a DCI using a scrambling sequence that is based on the subframe number of the first subframe of a bundle of subframes over which the DCI is transmitted. In some embodiments, the scrambling sequence is based on the total aggregated resource used for transmitting the DCI. According to an embodiment, the base station performs this scrambling operation after performing a CRC operation. In other embodiments, the base station performs this scrambling operation after carrying out channel encoding. In still other embodiments, the base station performs this scrambling operation after carrying out rate matching.

According to various embodiments, a UE descrambles bits of a DCI using a scrambling sequence that is based on the subframe number of the first subframe of a bundle of subframes. In some embodiments, the scrambling sequence is based on the total aggregated resource used for transmitting the DCI. According to an embodiment, the UE performs this scrambling operation after carrying out rate-dematching but before carrying out channel decoding (e.g., convolutional decoding). In other embodiments, the UE performs this scrambling operation after cell-specific descrambling but before performing rate-dematching. In other embodiments, the UE performs this scrambling operation after carrying out channel decoding but before performing a CRC-decoding operation.

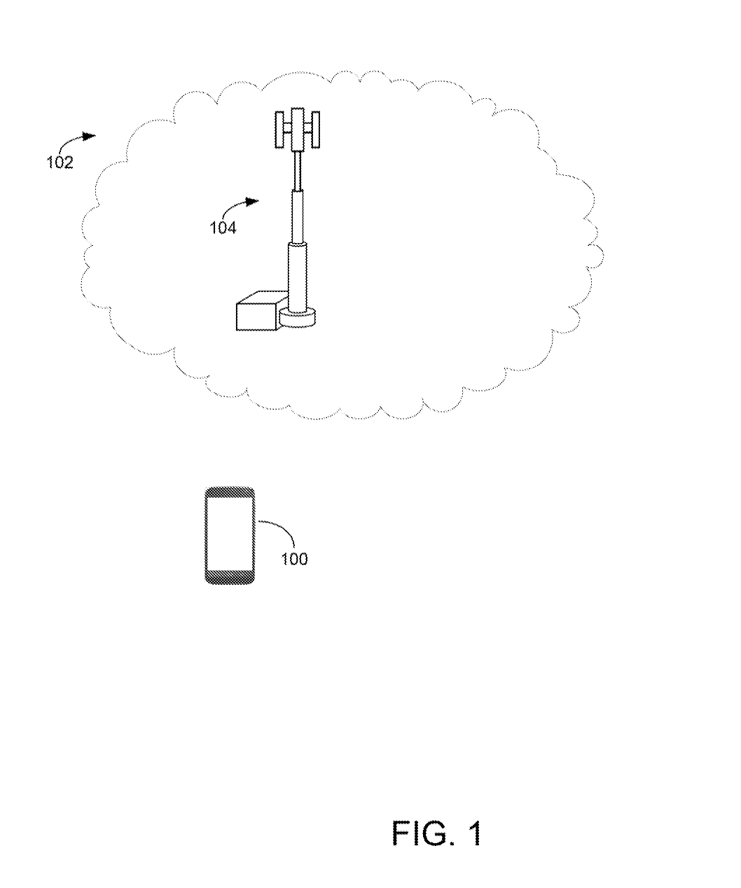

Turning to FIG. 1, a UE 100 is configured for wireless communication with a wireless network 102 via a base station 104. Possible implementations of the UE 100 include a mobile phone (e.g., smartphone), a tablet computer, a laptop, a sensor, an electricity-meter reader, a smart thermostat, or other computing device. In one embodiment, the wireless network 102 operates according to one of the 3GPP standards (such as LTE), and the base station 104 is an enhanced Node B.

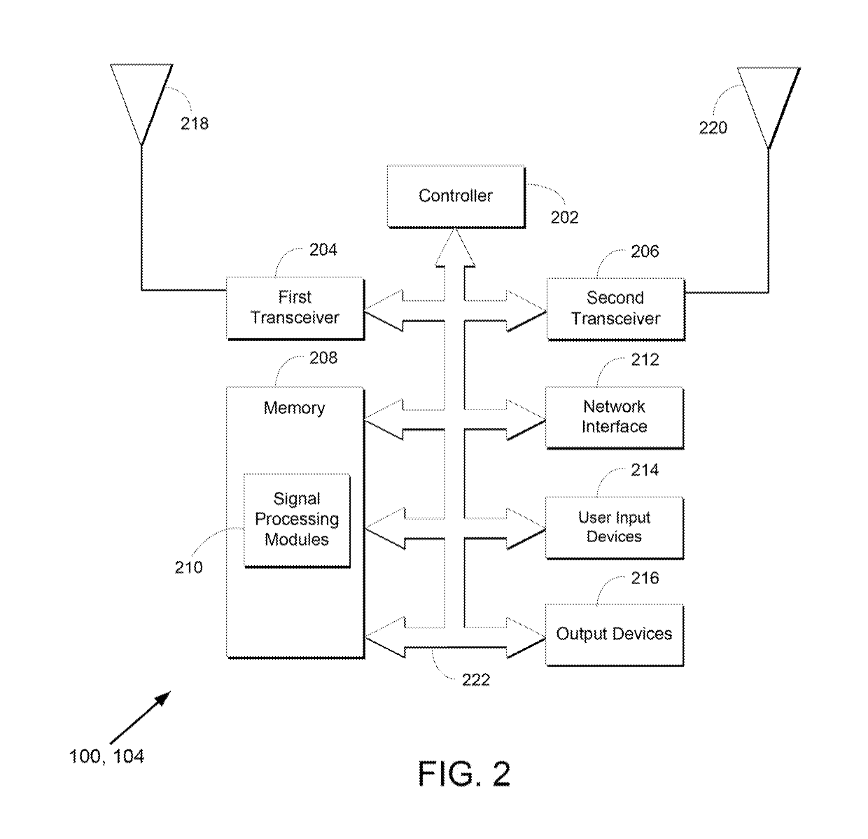

Turning to FIG. 2, a possible implementation of the UE 100 and the base station 104 (“the device”) includes a controller 202, a first transceiver 204 (e.g., a baseband chipset that includes a transceiver capable of communicating by radio according to a 3GPP standard), and a second transceiver 206. The device further includes a memory 208 (in which the instructions of various signal-processing modules 210 are stored), a network interface 212 (used, for example, by the base station 104 to communicate with other parts of the network 102), user-input devices 214 (e.g., a touchscreen and a microphone), output devices 216 (e.g., a display and a speaker), and antennas 218 and 220. The memory 208 can be implemented as volatile memory, non-volatile memory, or a combination thereof The memory 208 may be implemented in multiple physical locations and across multiple types of media (e.g., dynamic random-access memory plus a hard-disk drive). The memory 208 can also be split among multiple hardware components. In one embodiment, each of the controller 202, the first transceiver 204, and the second transceiver 206 has a separate memory, which is collectively represented by the memory 208. The controller 202 retrieves instructions (including those of the signal-processing modules 210) from the memory 208 and operates according to those instructions to carry out various functions, including providing outgoing data to and receiving incoming data from the first transceiver 204 and the second transceiver 206. Thus, when this disclosure refers to any of the signal-processing modules 210 carrying out an action, it is, in many embodiments, the controller 202 that actually carries out the action (in coordination with other pieces of hardware of the device as necessary).

Each of the elements of the UE 100 is communicatively linked to the other elements via data pathways 222. Possible implementations of the data pathways 222 include wires, conductive pathways on a microchip, and wireless connections. Possible implementations of the controller 202 include a microprocessor (such as a baseband processor), a microcontroller, a digital signal processor, and a field-programmable gate array.

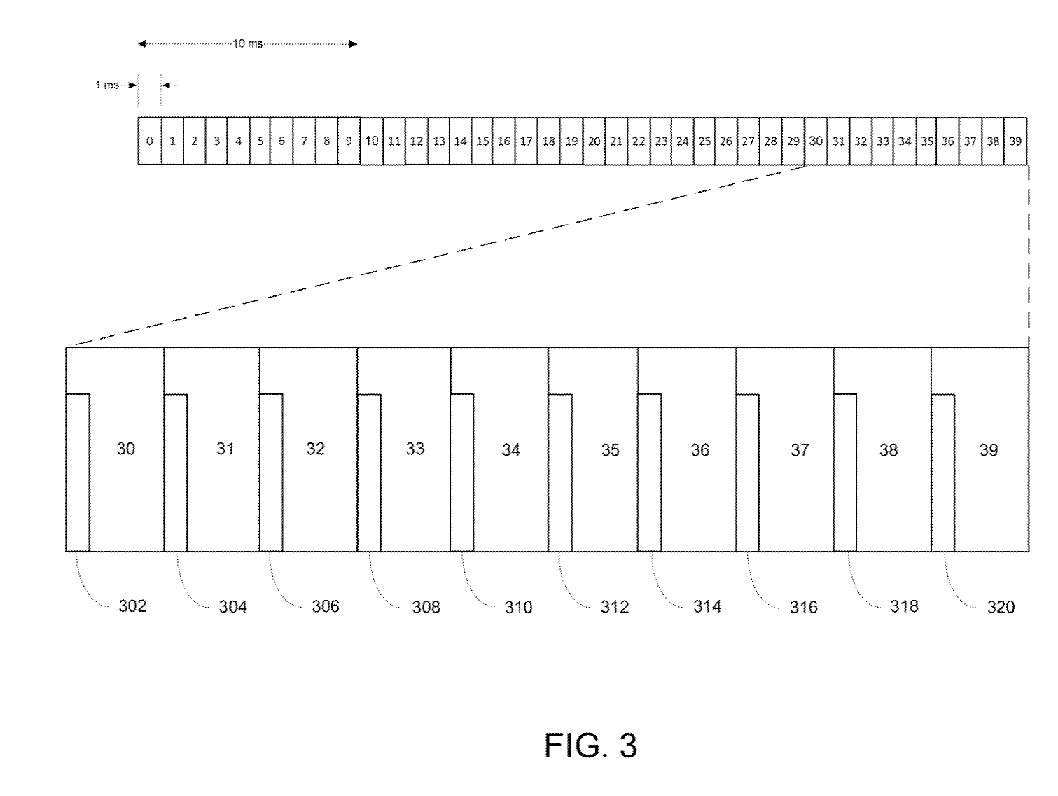

The base station 104 communicates with the UE 100 using radio frames, each of which is divided into a series of subframes. The base station 104 transmits DCI messages to the UE 100 on a control channel that is carried in one or more of the subframes. Examples of control channels include a PDCCH and an EPDCCH. In an embodiment, the base station 104 transmits multiple instances of a DCI message spread out over multiple subframes. For example, turning to FIG. 3, each radio frame in an embodiment is 10 milliseconds (“ms”) long. Each radio frame is divided into 10 subframes of 1 ms each. Each subframe includes a set of one or more CCEs, in which an instance of the DCI message is contained. For example, subframe 30 has a set 302 of CCEs, subframe 31 has a set 304 of CCEs, etc. Each set of CCEs of each of these 10 subframes has an instance of a DCI message for the UE 100. The UE 100 is capable of aggregating as many of these instances as it needs in order to decode the DCI successfully. The more instances over which the DCI is repeated, the more likely it is that the UE 100 will successfully decode it.

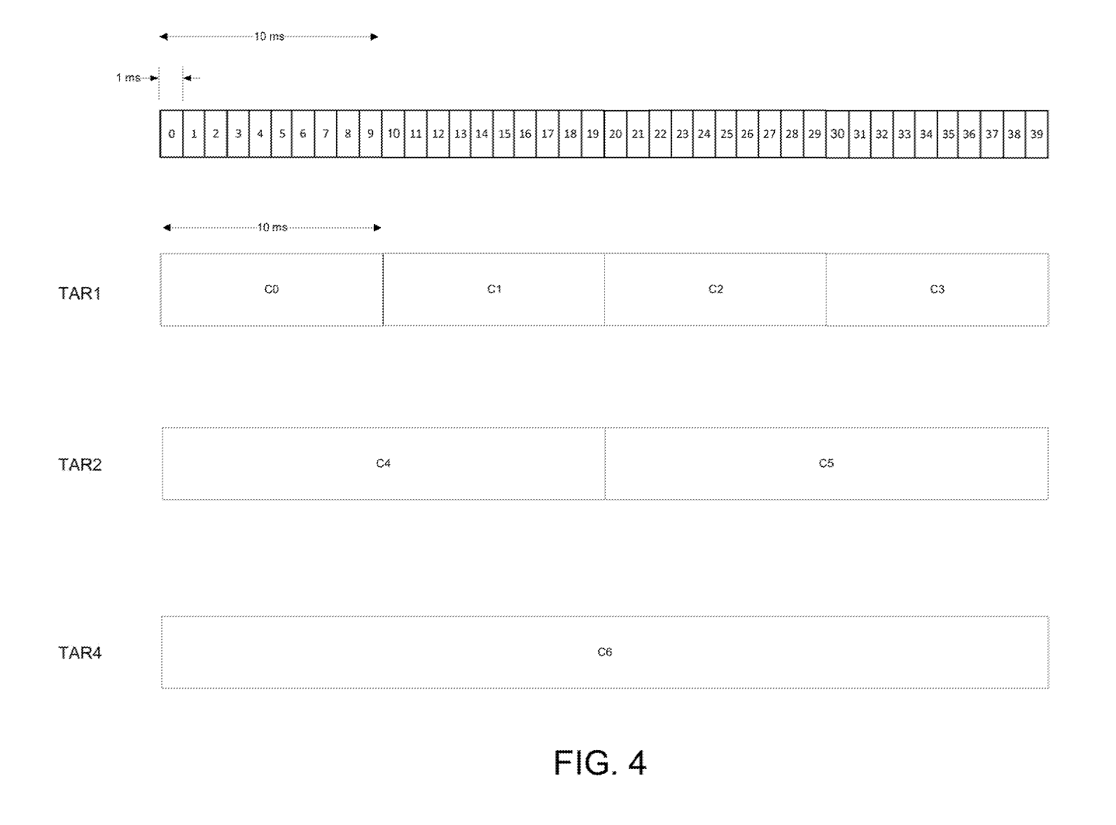

When the UE 100 receives transmissions from the base station 104, the UE 100 does not initially know how many CCEs the base station 104 used to carry the DCI message. Furthermore, it does not necessarily know the number of repetitions over which the base station 104 has transmitted the DCI message. Turning to FIG. 4, for example, the base station 104 may have repeated the DCI message over 10 subframes, starting from subframe 0 and ending at subframe 9. This entire set of resources over which the DCI message is transmitted is referred to as the total aggregated resource (“TAR”). A group of subframes in which each subframes includes an instance of a particular DCI message is referred to a “subframe bundle.” The label TART refers to the fact that the DCI message is repeated over the course of one radio frame. When the UE 100 attempts to decode the DCI message in that first radio frame, the set of CCEs in the radio frame for which the UE performs a decoding attempt is said to be a “candidate,” and is labeled in FIG. 4 as C0. For example, the first candidate may include of a total of eighty CCEs, with eight CCEs (indexed as CCE0, CCE1, CCE2, . . . , CCE7 within a subframe) in each subframe of a radio frame. Similarly, the UE 100 can attempt to decode the DCI in the second radio frame, which is labeled C1 (as in “candidate C1”), the third radio frame C2, and the fourth radio frame C3. The base station 104 can also repeat the DCI message in subframe bundles that span multiple radio frames. For example, the candidates C4 and C5 each span two radio frames and are referred to as having a TAR level of 2 (“TAR2”). Candidate C6 spans four radio frames and is referred to as having a TAR level of 4 (“TAR4”).

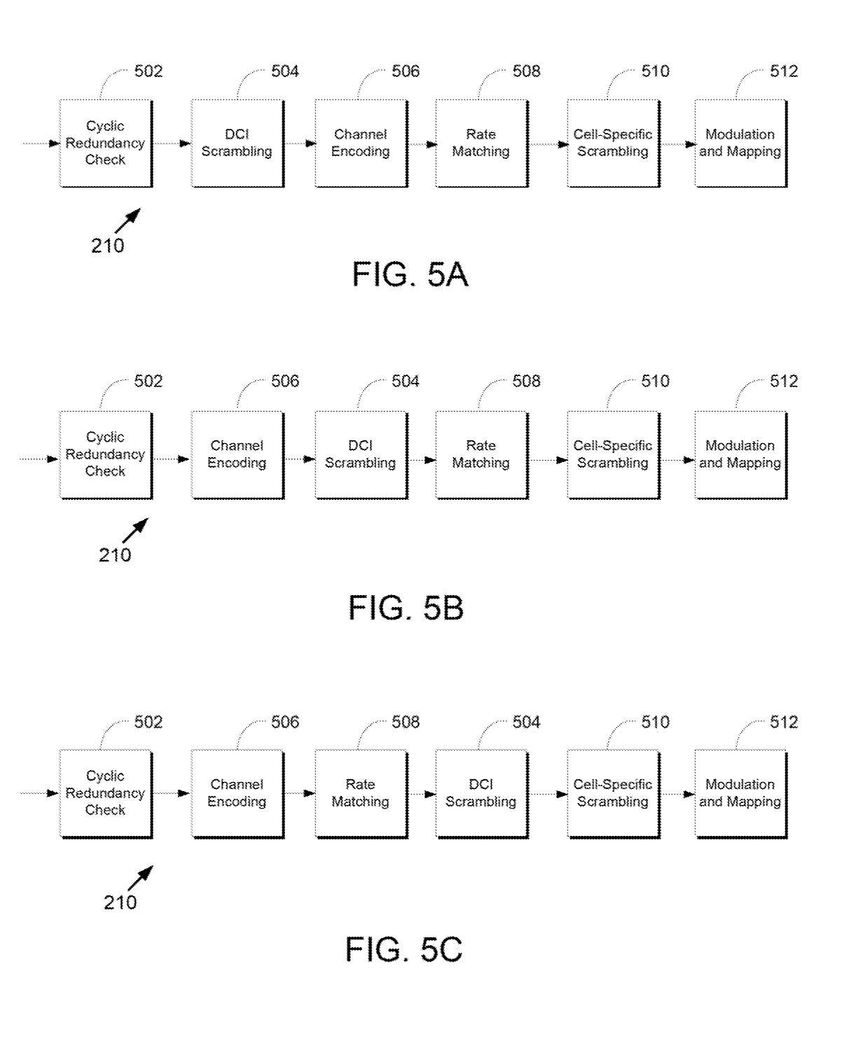

Turning to FIG. 5A, in an embodiment, the signal-processing modules 210 of the base station 104 include a cyclic-redundancy-check module 502, a DCI-scrambling module 504, a channel-encoding module 506 (e.g., a convolutional encoding module), a rate-matching module 508, a cell-specific scrambling module 510, and a modulation and mapping module 512. In transmitting the DCI to the UE 100, the modules carry out the following operations. The output from each of the modules acts as an input to the next module, as indicated by the arrows. Furthermore, the processing may be performed in other ways that result in an equivalent operation. In this embodiment, the cyclic-redundancy-check module 502 generates parity bits based on the DCI and attaches those bits to the DCI. The DCI-scrambling module 504: (a) scrambles the CRC portion of the output of the cyclic-redundancy-check module 502 to generate a second set of bits and (b) scrambles the second set of bits using a scrambling sequence that is based on the subframe number of the first subframe of the subframe bundle to generate a third set of bits. Thus, the scrambling-sequence length is the number of bits in the DCI plus the number of bits in the CRC. In some operations the scrambling-sequence length may be small if only a small portion of the DCI plus the number of bits in the CRC are scrambled. For example, if the starting subframe is limited to only four possible values, then the scrambling sequence may be only two bits long (e.g., 00, 01, 10, or 11), hence only two bits of the encoded DCI are scrambled. The channel-encoding module 506 encodes the third set of bits to generate parity bits. The rate-matching module 508 rate matches the parity bits, resulting in rate-matched parity bits. The cell-specific scrambling module 510 scrambles the rate-matched parity bits in a cell-specific manner. The modulation and mapping module 512 modulates the signals that are to carry the DCI and maps the signals to resource elements. There may be other processing modules as well. For example, in the case of orthogonal frequency-division multiplexing, the software modules include modules to associate the resource elements with subcarriers (i.e., in the frequency domain) and perform an inverse Fast Fourier Transform operation to obtain a time-domain signal. These steps are typically followed by other operations to prepare a transmission.

The base station 104 transmits the output of the modulation and mapping module 512 via the first transceiver 204 and the antenna 218. The base station 104 (using the signal-processing modules 210) carries out these operations for each subframe of the subframe bundle. Thus, the subframe number of the first subframe of the bundle will, in effect, be encoded into the parity bits of each instance of the DCI in each of the subframes of the bundle. For example, if the subframe bundle includes the subframes 30, 31, 32, 33, 34, 35, 36, 37, 38, and 39, then the DCI-scrambling module 504 could encode the number 30 (or a function that indicates the number 30) into the parity bits. Continuing with the example of FIG. 3, this means that the subframe number would be encoded with the DCI on the CCEs 302, the CCEs 304, . . . , and the CCEs 320.

Turning to FIG. 5B, in another embodiment, the signal-processing modules 210 of the base station 104 perform their respective functions in a different order. In this embodiment, the cyclic-redundancy-check module 502 generates parity bits based on the DCI and attaches those bits to the DCI. The channel encoder 506 encodes the output of the cyclic-redundancy-check module 502, including the parity bits. The DCI-scrambling module 504 then scrambles the channel-coded output of channel encoder 506 using a scrambling sequence that is based on the subframe number of the first subframe of the subframe bundle. In this embodiment, the scrambling sequence length is:

$$\frac{\begin{matrix}the number of bits in the DCI + \\ the number of bits in the CRC\end{matrix}}{R} .$$

where R is code rate of the channel coding. For example, the rate is 1/3 for a convolutional encoder used in Release 8 of LTE for the DCI transmission. The rate-matching module 508, cell-specific scrambling module 510, and modulation and mapping module 512 each performs its respective functions in the same manner described above in conjunction with FIG. 5A. The base station 104 transmits the output of the modulation and mapping module 512 via the first transceiver 204 and the antenna 218. The base station 104 (using the signal-processing modules 210) carries out these operations for each subframe of the subframe bundle.

Turning to FIG. 5C, in still another embodiment, the signal-processing modules 210 of the base station 104 perform their respective functions in another order. In this embodiment, the cyclic-redundancy-check module 502 generates parity bits based on the DCI and attaches those bits to the DCI. The channel encoder 506 encodes the output of the cyclic-redundancy-check module 502, including the parity bits. The rate-matching module 508 rate matches the parity bits to generate rate-matched parity bits. The DCI-scrambling module 504 scrambles the parity bits using a scrambling sequence that is based on the subframe number of the first subframe of the subframe bundle. In this embodiment, the scrambling sequence length is:

$$\frac{\begin{matrix}the number of bits in the DCI + \\ the number of bits in the CRC\end{matrix}}{{R}_{eff}} ,$$

where R_{eff} is code-rate based on the available number of coded bits to transmit the DCI in one subframe. The modulation and mapping module 512 performs its function in the same manner described above in conjunction with FIG. 5A. The base station 104 transmits the output of the modulation and mapping module 512 via the first transceiver 204 and the antenna 218. The base station 104 (using the signal-processing modules 210) carries out these operations for each subframe of the subframe bundle.

In the embodiments of FIG. 5A, FIG. 5B, and FIG. 5C, according to an embodiment, the TAR size is based on the number of subframes in the subframe bundle as well as on the resource size (e.g., the number of CCEs used) in each subframe of the subframe bundle. The TAR size may be selected from a set of known values (e.g., {1, 2, 4}). In some embodiments, the scrambling sequence is based on the TAR used for transmitting the DCI as well as on the subframe number of the first subframe.

In the embodiments of FIG. 5A, FIG. 5B, and FIG. 5C, the scrambling initialization cᵢₙᵢₜ for the DCI-scrambling module 504 is given by cᵢₙᵢₜ=f(nₛ,nₛₜₐᵣₜ^{DCI},TAR_{DCI}) where f is a function, nₛₜₐᵣₜ^{DCI} is the slot number (or subframe number) of the first CCE (of a TAR) in which the DCI is transmitted, TAR_{DCI} denotes the TAR indicator for the DCI (e.g., 0 for TAR1, 1 for TAR2, and 2 for TAR4), and nₛ denotes the current slot number. In one example, cᵢₙᵢₜ=└nₛₜₐᵣₜ^{DCI}/2┘·2⁹+TAR_{DCI}. In another example, cᵢₙᵢₜ=└nₛₜₐᵣₜ^{DCI}/2┘·2⁹. In another example, for EPDCCH, cᵢₙᵢₜ=└nₛₜₐᵣₜ^{DCI}/2┘·2⁹+n_{ID,m}^{EPDCCH}, where n_{ID,m}^{EPDCCH} is a scrambling identifier that is part of the EPDCCH configuration indicated by higher layer signaling. Note that the slot number can be replaced by a corresponding subframe number for equivalence. The scrambling initialization seed may be used with a scrambling-sequence generator (such as defined in the 3GPP LTE specification) to generate scrambling sequences.

According to various embodiments, the signal-processing modules 210 of the UE 100 have a function inverse of those of the base station 104 and may also have arrangements that mirror those of FIG. 5A, FIG. 5B, and FIG. 5C.

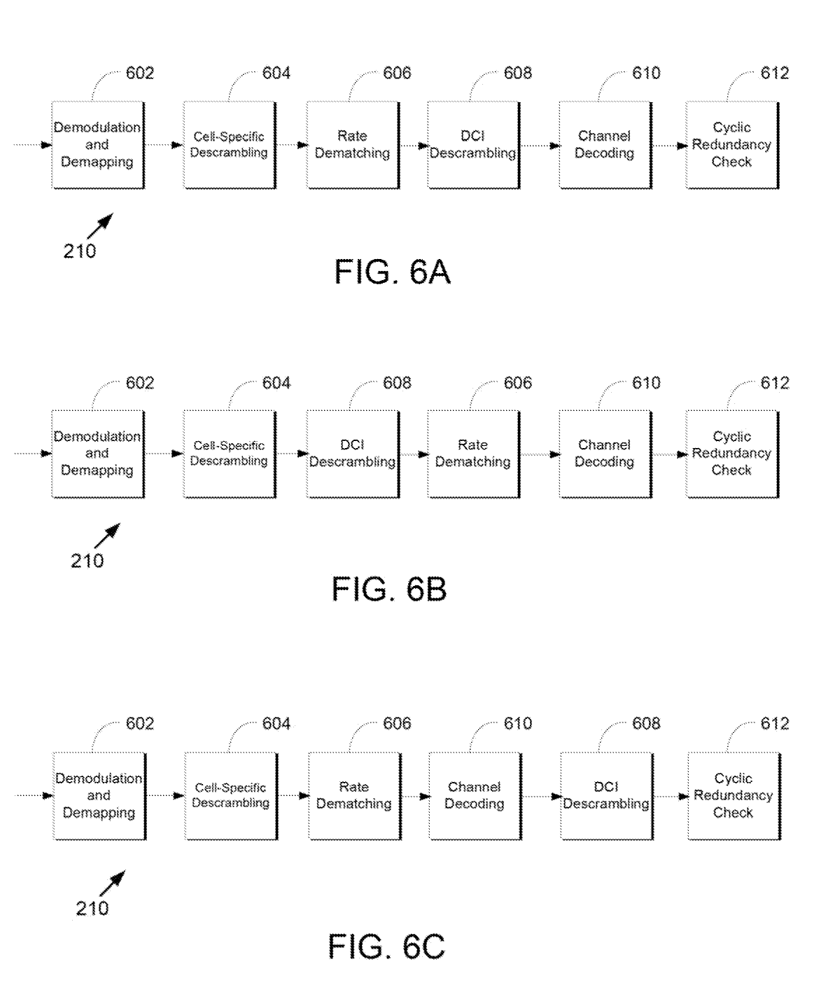

Turning to FIG. 6A, in an embodiment, the signal-processing modules 210 of the UE 100 include a demodulation and demapping module 602, a cell-specific descrambling module 604, a rate-dematching module 606, a DCI-descrambling module 608, a channel-decoding module 610, and a cyclic-redundancy-check module 612. When the UE 100 receives the subframe bundle from the base station 104, the modules 210 carry out the following operations. The output from each of the modules acts as an input to the next module, as indicated by the arrows. In this embodiment, the UE 100 receives a first signal in one subframe of the bundle and a second signal in another subframe of the bundle. The UE 100 soft combines the first signal and the second signal. The demodulation and demapping module 602 demodulates and demaps the soft-combined signals, and the cell-specific descrambling module 604 descrambles the output of the demodulation and demapping module 602. The rate-dematching module 606 rate dematches the output of the cell-specific descrambling module 604. The DCI-descrambling module 608 descrambles the output of the rate-dematching module 606 based on the subframe number of the first subframe of the subframe bundle. The channel-decoding module 610 decodes the output of the DCI-descrambling module 608. The cyclic-redundancy-check module 612 performs a CRC check on the output of the channel-decoding module 610.

Turning to FIG. 6B, in another embodiment, the signal-processing modules 210 of the UE 100 are ordered so that the DCI-descrambling module 608 comes after the cell-specific descrambling module 604. When the UE 100 receives the subframe bundle from the base station 104, the modules 210 carry out the following operations. The UE 100 receives a first signal in one subframe of the bundle and a second signal in another subframe of the bundle. The UE 100 soft combines the first signal and the second signal. The demodulation and demapping module 602 demodulates and demaps the soft-combined signals, and the cell-specific descrambling module 604 descrambles the output of the demodulation and demapping module 602. The DCI-descrambling module 608 descrambles the output of the cell-specific descrambling module 604 based on the subframe number of the first subframe of the subframe bundle. The rate-dematching module 606 rate dematches the output of the DCI-descrambling module 608. The channel-decoding module 610 decodes the output of the rate-dematching module 606. The cyclic-redundancy-check module 612 performs a CRC check on the output of the channel-decoding module 610.

Turning to FIG. 6C, in another embodiment, the signal-processing modules 210 of the UE 100 are ordered so that the DCI-descrambling module 608 comes after the channel-decoding module 610. When the UE 100 receives the subframe bundle from the base station 104, the modules carry out the following operations. The UE 100 receives a first signal in one subframe of the bundle and a second signal in another subframe of the bundle. The UE 100 soft combines the first signal and the second signal. The demodulation and demapping module 602 demodulates and demaps the soft-combined signals, and the cell-specific descrambling module 604 descrambles the output of the demodulation and demapping module 602. The rate-dematching module 606 rate dematches the output of the cell-specific descrambling module 604. The channel-decoding module 610 decodes the output of the rate-dematching module 606. The DCI-descrambling module 608 descrambles the output of the channel-decoding module 610 based on the subframe number of the first subframe of the subframe bundle. The cyclic-redundancy-check module 612 performs a CRC check on the output of the DCI-descrambling module 608.

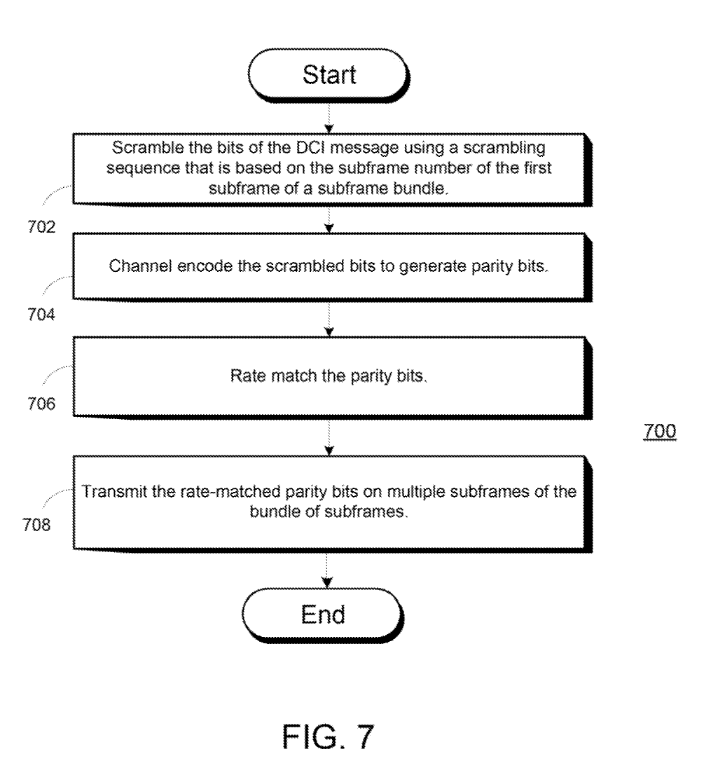

Turning to FIG. 7, a flowchart 700 depicts actions carried out by the base station 104 to transmit a DCI message to the UE 100 in an embodiment. At step 702, the base station 104 scrambles the bits of the DCI message using a scrambling sequence that is based on the subframe number of the first subframe of a subframe bundle. At step 704, the base station 104 channel encodes the scrambled bits to generate parity bits. At step 706, the base station 104 rate-matches the parity bits. At step 708, the base station 104 transmits the rate-matched parity bits on multiple subframes of the subframe bundle.

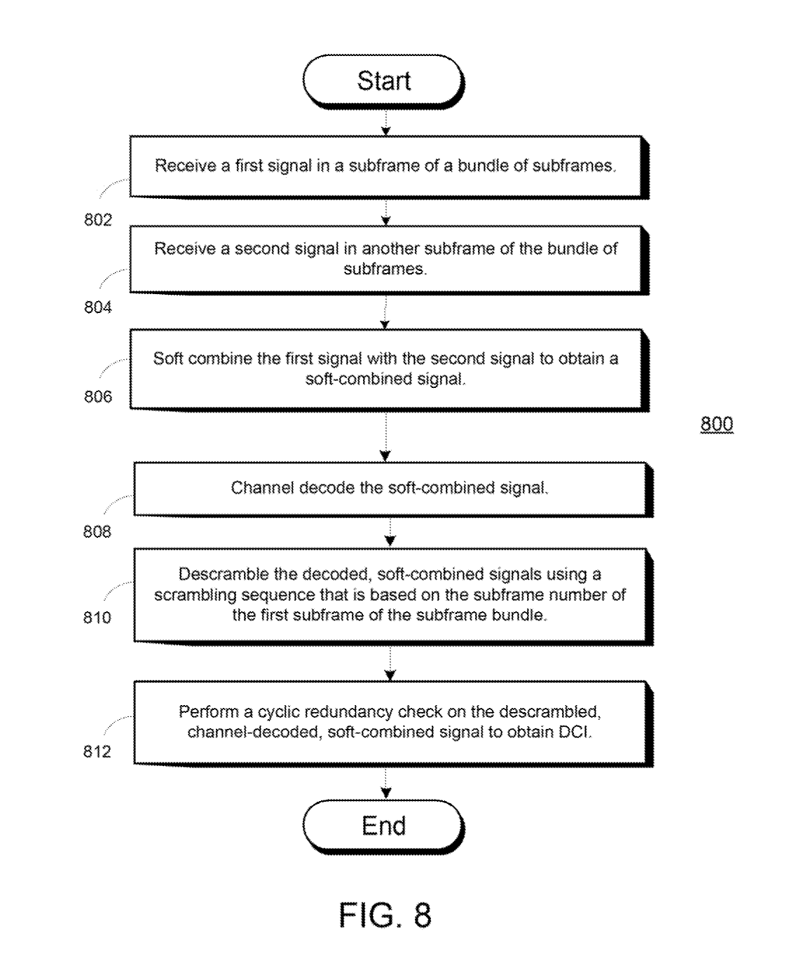

Turning to FIG. 8, a flowchart 800 depicts actions carried out by the UE 100 to receive a DCI message from the base station 104 in another embodiment. At step 802, the UE 100 receives a first signal in a subframe of a bundle of subframes. At step 804, the UE 100 receives a second signal in another subframe of the bundle of subframes. At step 806, the UE 100 soft combines the first signal with the second signal to obtain a soft-combined signal. At step 808, the UE 100 channel decodes the soft-combined signal. At step 810, the UE 100 descrambles the decoded, soft-combined signals using a scrambling sequence that is based on the subframe number of the first subframe of the subframe bundle. At step 812 the UE 100 performs a cyclic redundancy check on the descrambled, channel-decoded, soft-combined signal to obtain the DCI.

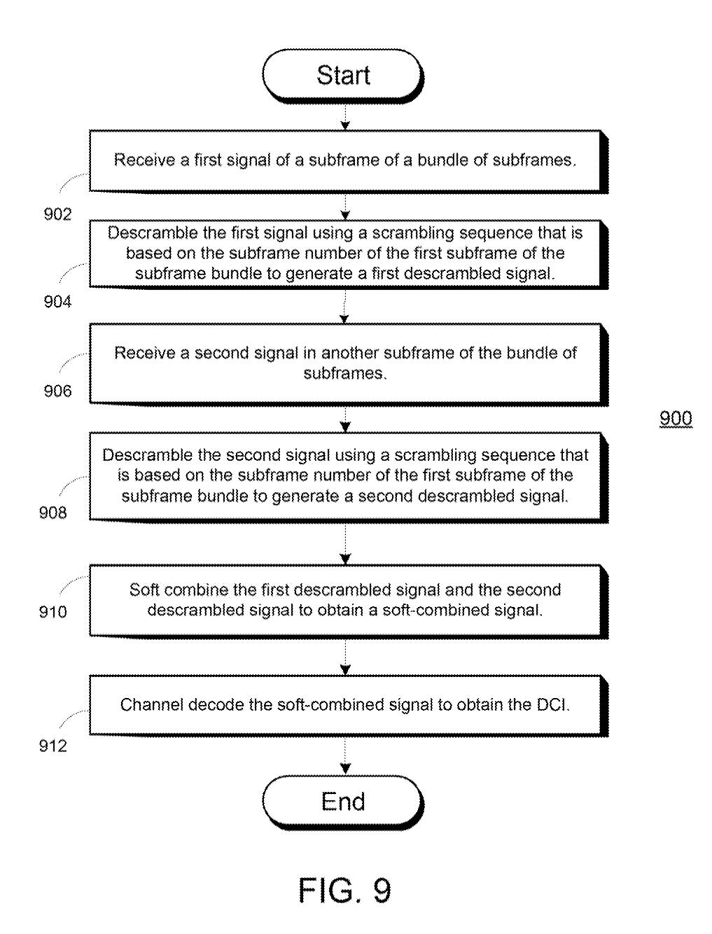

Turning to FIG. 9, a flowchart 900 depicts actions carried out by the UE 100 to receive a DCI message from the base station 104 in another embodiment. At step 902, the UE 100 receives a first signal in a subframe of a bundle of subframes. At step 904, the UE 100 descrambles the first signal using a scrambling sequence that is based on the subframe number of the first subframe of the subframe bundle to generate a first descrambled signal. At step 906, the UE 100 receives a second signal in another subframe of the bundle of subframes. At step 908, the UE 100 descrambles the second signal using a scrambling sequence that is based on the subframe number of the first subframe of the subframe bundle to generate a second descrambled signal. At step 910, the UE 100 soft combines the first descrambled signal and the second descrambled signal to obtain a soft-combined signal. At step 912, the UE 100 channel decodes the soft-combined signal to obtain the DCI.

In view of the many possible embodiments to which the principles of the present discussion may be applied, it should be recognized that the embodiments described herein with respect to the drawing figures are meant to be illustrative only and should not be taken as limiting the scope of the claims Therefore, the techniques as described herein contemplate all such embodiments as may come within the scope of the following claims and equivalents thereof.

We claim:

1. A method, on a base station, for multi-frame transmission of control information to a user equipment (“UE”), the method comprising:
scrambling bits of downlink-control information (“DCI”) using a scrambling sequence that is based on a subframe number of a first subframe of a subframe bundle;
channel encoding the sequence of bits using a channel encoder to generate parity bits;
rate matching the parity bits; and
transmitting the rate-matched parity bits on multiple subframes of the subframe bundle.

2. The method of claim 1 wherein the scrambling sequence is further based on a total aggregated resource used for transmitting the DCI.

3. The method of claim 1 wherein channel encoding the sequence of bits comprises convolutionally coding the sequence of bits.

4. The method of claim 1 wherein a total aggregated resource size of the DCI is based on a number of subframes in the subframe bundle and a size of resources used for the DCI in each subframe of the subframe bundle.

5. The method of claim 1 wherein transmitting the rate-matched parity bits comprises transmitting the rate-matched parity bits on either a physical downlink-control channel or an enhanced physical downlink-control channel.

6. A method, on a user equipment (“UE”), for multi-subframe reception of control information from a base station, the method comprising:
receiving a first signal in a subframe of a bundle of subframes;
receiving a second signal in another subframe of the bundle of subframes;
soft combining the first signal with the second signal to obtain a soft-combined signal;
channel decoding the soft-combined signal;
descrambling the channel-decoded, soft-combined signal using a scrambling sequence that is based on a subframe number of a first subframe of the subframe bundle; and
performing a cyclic redundancy check on the descrambled, channel-decoded, soft-combined signal to obtain downlink-control information (“DCI”).

7. The method of claim 6 wherein the scrambling sequence is further based on a total aggregated resource used for transmitting the DCI.

8. The method of claim 6 wherein channel decoding the sequence of bits comprises convolutionally decoding the sequence of bits.

9. The method of claim 6 wherein a total aggregated resource size of the DCI is based on a number of subframes in the subframe bundle and a size of resources used for the DCI in each subframe of the subframe bundle.

10. The method of claim 6 wherein receiving the first signal comprises receiving the first signal on either a physical downlink-control channel or an enhanced physical downlink-control channel.

11. A method, on a user equipment (“UE”), for multi-subframe reception of control information from a base station, the method comprising:
receiving a first signal in a subframe of a bundle of subframes;
descrambling the first signal using a scrambling sequence that is based on a subframe number of a first subframe of the subframe bundle to generate a first descrambled signal;
receiving a second signal in another subframe of the bundle of subframes;
descrambling the second signal using a scrambling sequence that is based on a subframe number of a first subframe of the subframe bundle to generate a second descrambled signal;
soft combining the first descrambled signal and the second descrambled signal to obtain a soft-combined signal; and
channel decoding the soft-combined signal to obtain downlink-control information (“DCI”).

12. The method of claim 11 wherein the scrambling sequence is further based on a total aggregated resource used for transmitting the DCI.

13. The method of claim 11 wherein channel decoding the soft-combined signal comprises convolutionally decoding the soft-combined signal.

14. The method of claim 11 wherein a total aggregated resource size of the DCI is based on a number of subframes in the subframe bundle and a size of resources used for the DCI in each subframe of the subframe bundle.

15. The method of claim 11 wherein receiving the first signal comprises receiving the first signal on either a physical downlink-control channel or an enhanced physical downlink-control channel.
